(19) United States
(12) Patent Application Publication
(10) Pub. No.: US 2025/0040582 A1
(43) Pub. Date: Feb. 6, 2025

(54) FLAVOR-MODIFYING COMPOSITIONS CONTAINING LACTASE

(71) Applicant: Firmenich SA, Satigny (CH)

(72) Inventors: Jean-Luc GELIN, Satigny (CH); Dattatreya BANAVARA, Plainsboro, NJ (US)

(73) Assignee: Firmenich SA, Satigny (CH)

(21) Appl. No.: 18/566,390

(22) PCT Filed: Jun. 22, 2022
(86) PCT No.: PCT/EP2022/067001

§ 371 Date: Dec. 1, 2023

Related U.S. Application Data
(60) Provisional application No. 63/213,919, filed on Jun. 23, 2021.

(30) Foreign Application Priority Data
Jul. 15, 2021 (EP) 21185920.2

(51) Int. Cl. A23L 27/00; A23C 9/156; A23L 27/20; A23L 27/30; A23L 29/00

(52) U.S. Cl. CPC A23L 27/88; A23C 9/156; A23L 27/2056; A23L 27/33; A23L 29/06

(57) ABSTRACT

The present disclosure relates generally to flavor-modifying compositions and their use in various comestible products, such as food products, beverage products, nutritional products, including dairy products. In some embodiments, the flavor-modifying compositions include lactase. In some embodiments, the flavor-modifying compositions include one or more sweetness enhancers. In some embodiments, the flavor-modifying compositions also include one or more flavorings, such as sweeteners, including, but not limited to, sugars, high-intensity sweeteners, or combinations thereof. In some aspects, the disclosure provides the use of such flavor-modifying compositions in various comestible compositions. Such comestible compositions include various additional components, such as animal proteins (for example, dairy proteins), non-animal proteins, and the like. Such comestible compositions can be packaged as or included in food products, beverage products, or animal feed products. In some embodiments, such products are dairy products, such as dairy-based beverages, yogurt, cheese, condensed milk, evaporated milk, powdered milk, infant formula, buttermilk, kefir, cream, creamer, custard, ice cream, gelato, frozen custard, frozen custard, cottage cheese, and the like.

### TECHNICAL FIELD

The present disclosure relates generally to flavor-modifying compositions and their use in various comestible products, such as food products, beverage products, nutritional products, including dairy products. In some embodiments, the flavor-modifying compositions include lactase. In some embodiments, the flavor-modifying compositions include one or more sweetness enhancers. In some embodiments, the flavor-modifying compositions also include one or more flavorings, such as sweeteners, including, but not limited to, sugars, high-intensity sweeteners, or combinations thereof. In some aspects, the disclosure provides the use of such flavor-modifying compositions in various comestible compositions. Such comestible compositions include various additional components, such as animal proteins (for example, dairy proteins), non-animal proteins, and the like. Such comestible compositions can be packaged as or included in food products, beverage products, or animal feed products. In some embodiments, such products are dairy products, such as dairy-based beverages, yogurt, cheese, condensed milk, evaporated milk, powdered milk, infant formula, buttermilk, kefir, cream, creamer, custard, ice cream, gelato, frozen custard, frozen custard, cottage cheese, and the like.

### DESCRIPTION OF RELATED ART

The taste system provides sensory information about the chemical composition of the external world. Taste transduction is one of the more sophisticated forms of chemically triggered sensation in animals. Signaling of taste is found throughout the animal kingdom, from simple metazoans to the most complex of vertebrates. Mammals are believed to have five basic taste modalities: sweet, bitter, sour, salty, and umami.

Sweetness is the taste most commonly perceived when eating foods rich in sugars. Mammals generally perceive sweetness to be a pleasurable sensation, except in excess. Caloric sweeteners, such as sucrose and fructose, are the prototypical examples of sweet substances. Although a variety of zero-calorie and low-calorie substitutes exist, these caloric sweeteners are still the predominant means by which comestible products induce the perception of sweetness upon consumption.

Metabolic disorders and related conditions, such as obesity, diabetes, and cardiovascular disease, are major public health concerns throughout the world. And their prevalence is increasing at alarming rates in almost every developed country. Caloric sweeteners are a key contributor to this trend, as they are included in various packaged food and beverage products to make them more palatable to consumers. In many cases, no-calorie or low-calorie substitutes can be used in foods and beverages in place of sucrose or fructose. Even so, these compounds impart sweetness differently from caloric sweeteners, and a number of consumers fail to view them as suitable alternatives. Moreover, such compounds may be difficult to incorporate into certain products. In some instances, they may be used as partial replacements for caloric sweeteners, but their mere presence can cause many consumers to perceive unpleasant off-tastes including, astringency, bitterness, and metallic and licorice tastes. Thus, lower-calorie sweeteners face certain challenges to their adoption.

Sweetening dairy products using such sweeteners is quite common. Dairy products typically contain sugar naturally as well in the form of lactose. Lactose is a disaccharide composed of D-galactose and D-glucose connected by a 1,4-β linkage. Therefore, when sweetening dairy products, one also faces the challenges presented by the presence and flavor of lactose in the sweetened product.

Therefore, there is a need to discover new compositions that can more effectively mimic the sensory profile of caloric sweeteners, such as sucrose, in flavored products, such as various dairy products.

### SUMMARY

The present disclosure relates to the discovery that lactase enzymes, used in combination with certain sweetness enhancers, can improve the sweetness of dairy products without requiring the addition of substantial amounts of caloric sweetener, such as sucrose of fructose.

In a first aspect, the disclosure provides a flavor-modifying composition comprising: (a) a lactase, and (b) a sweetener, a sweetness enhancer, or a combination thereof. In some embodiments, the flavor-modifying composition comprises a sweetener, such as a natural steviol glycoside sweetener (rebaudioside A, rebaudioside M, etc.), sucralose, allulose, and the like. In some embodiments, the flavor-modifying composition comprises a sweetness enhancer, such as phloretin, naringenin, glucosylated natural steviol glycosides, or synthetic compounds such as N-(1-((4-amino-2,2-dioxo-1H-benzo[c][1,2,6]thiadiazin-5-yl)oxy)-2-methylpropan-2-yl)isonicotinamide, or any of its comestbly acceptable salts. In some embodiments, the flavor-modifying composition includes vanillin or an analogue thereof.

In a second aspect, the disclosure provides uses of any flavor-modifying compositions of the first aspect to increase or enhance a sweet taste of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of increasing or enhancing a sweet taste of a comestible composition, the method comprising introducing any flavor-modifying compositions of the first aspect to the comestible composition.

In a third aspect, the disclosure provides uses of any flavor-modifying compositions of the first aspect to reduce or block the bitterness of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of reducing or blocking the sweetness of a comestible composition, the method comprising introducing any flavor-modifying compositions of the first aspect to the comestible composition.

In a fourth aspect, the disclosure provides uses of any flavor-modifying compositions of the first aspect to reduce the perceived astringency of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of reducing the perceived astringency of a comestible composition, the method comprising introducing any flavor-modifying compositions of the first aspect to the comestible composition.

In a fifth aspect, the disclosure provides uses of any flavor-modifying compositions of the first aspect to reduce the perception of green taste notes (e.g., pea notes) of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of reducing the perception of green taste notes (e.g., pea notes) of a comestible composition, the method comprising introducing any flavor-modifying compositions of the first aspect to the comestible composition.

In a sixth aspect, the disclosure provides uses of any flavor-modifying compositions of the first aspect to reduce the perception of cereal taste notes of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of reducing the perception of cereal taste notes of a comestible composition, the method comprising introducing any flavor-modifying compositions of the first aspect to the comestible composition.

In a seventh aspect, the disclosure provides uses of any flavor-modifying compositions of the first aspect to enhance the perceived creaminess of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of enhancing the perceived creaminess of a comestible composition, the method comprising introducing any flavor-modifying compositions of the first aspect to the comestible composition.

In an eighth aspect, the disclosure provides uses of any flavor-modifying compositions of the first aspect to enhance the perceived fattiness of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of enhancing the perceived fattiness of a comestible composition, the method comprising introducing any flavor-modifying compositions of the first aspect to the comestible composition.

In a ninth aspect, the disclosure provides uses of any flavor-modifying compositions of the first aspect to increase or enhance a savory taste (such as an umami or a kokumi taste) of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of increasing or enhancing a savory taste (such as an umami or kokumi taste) of a comestible composition, the method comprising introducing any flavor-modifying compositions of the first aspect to the comestible composition.

In a tenth aspect, the disclosure provides uses of any flavor-modifying compositions of the first aspect to enhance the mouthfeel or mouthcoating of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of increasing the mouthfeel or mouthcoating of a comestible composition, the method comprising introducing any flavor-modifying compositions of the first aspect to the comestible composition.

In an eleventh aspect, the disclosure provides uses of any flavor-modifying compositions of the first aspect to enhance the perceived juiciness of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of enhancing the perceived juiciness of a comestible composition, the method comprising introducing any flavor-modifying compositions of the first aspect to the comestible composition.

In a twelfth aspect, the disclosure provides uses of any flavor-modifying compositions of the first aspect to enhance the perceived thickness of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of enhancing the perceived thickness of a comestible composition, the method comprising introducing any flavor-modifying compositions of the first aspect to the comestible composition.

In a thirteenth aspect, the disclosure provides uses of any flavor-modifying compositions of the first aspect to enhance the vanillic character of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of enhancing the vanillic character of a comestible composition, the method comprising introducing any flavor-modifying compositions of the first aspect to the comestible composition.

In a fourteenth aspect, the disclosure provides comestible compositions that comprising any flavor-modifying compositions of the first aspect. In some embodiments, the comestible compositions are flavored products, such as beverage products, such as dairy or dairy analogue products. In some other embodiments, the flavored products are food products, such as yogurt. In some embodiments, the flavored products are animal feed product, such as cat feed or dog feed products. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose).

In a fifteenth aspect, the disclosure provides flavored products, which comprise any comestible compositions of the fourteenth aspect. In some embodiments, the flavored products are beverage products, such as dairy or dairy analogue products. In some other embodiments, the flavored products are food products, such as yogurt. In some embodiments, the flavored products are animal feed product, such as cat feed or dog feed products. In some embodiments, the flavored products are oral care products.

Further aspects, and embodiments thereof, are set forth below in the Detailed Description, the Abstract, and the Claims.

### BRIEF DESCRIPTION OF THE DRAWINGS

The following drawings are provided for purposes of illustrating various embodiments of the compositions and methods disclosed herein. The drawings are provided for illustrative purposes only, and are not intended to describe any preferred compositions or preferred methods, or to serve as a source of any limitations on the scope of the claimed inventions.

FIG. 1 shows the chemical structure of N-(1-((4-amino-2,2-dioxo-1H-benzo[c][1,2,6]thiadiazin-5-yl)oxy)-2-methylpropan-2-yl)isonicotinamide, which, along with its comestible acceptable salts, can be suitably used in certain embodiments of the flavor-modifying compositions disclosed herein.

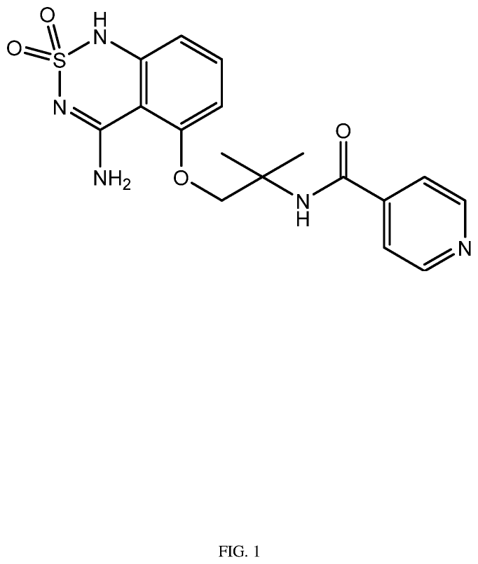

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary

As used herein, “sweetener,” “sweet flavoring agent,” “sweet flavor entity,” or “sweet compound” all refer to a compound or a comestibly acceptable salt thereof that elicits a detectable sweet flavor in a subject, such as a compound that activates a human T1R2 or T1R3 receptor in the course of in vitro screening or that is reported to be sweet via sensory testing by human subjects.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “optionally” means that the subsequently described event(s) may or may not occur. In some embodiments, the optional event does not occur. In some other embodiments, the optional event does occur one or more times.

As used herein, “or” is to be given its broadest reasonable interpretation, and is not to be limited to an either/or construction. Thus, the phrase “comprising A or B” means that A can be present and not B, or that B is present and not A, or that A and B are both present. Further, if A, for example, defines a class that can have multiple members, e.g., A₁ and A₂, then one or more members of the class can be present concurrently.

Other terms are defined in other portions of this description, even though not included in this subsection.

### Flavor-Modifying Compositions

In certain aspects, the disclosure provides a flavor-modifying composition comprising: (a) a lactase, and (b) a sweetener, a sweetness enhancer, or a combination thereof.

As used herein, the term “lactase” refers to any enzyme capable of hydrolyzing the disaccharide lactose into its constituent monosaccharides, D-galactose and D-glucose. Any suitable lactase can be used, including, but not limited to, naturally occurring lactases, lactases derived from yeast extracts, or any other such enzyme capable of hydrolyzing an amount of lactose into its constituent monosaccharides. In some embodiments, the lactases are isolated from organisms, including microorganisms. In some such embodiments, the lactases are an intracellular component of microorganisms such as Kluyveromyces and Bacillus. In some other embodiments, the lactases are fungal lactases, such as lactases derived from Kluyveromyces, such as K. fragilis and K. lactis, and other fungi such as those of the genera Candida, Torula, and Torulopsis. In some other embodiments, the lactases are bacterial lactases, such as B. coagulans and B circulans bacterial lactases.

Such lactase preparations derived from such organisms are available commercially. For example, in some embodiments, LACTOZYM (Novozymes, Denmark), HA-Lactase (Chr. Hansen, Denmark), and MAXILACT (DSM, Netherlands), each of which is produced from K. lactis, can be suitably used in the flavor-modifying compositions set forth herein. In some other embodiments, SAPHERA (Novozymes, Denmark), GODO-YNL2 (DuPont, Wilmington, Del., US), and Lactase F100-SD (Amano) are used in the flavor-modifying compositions disclosed herein. Other lactase preparations suitable for use in the flavor-modifying compositions disclosed herein include the lactase preparations set forth in PCT Publication No. WO 2009/071539. In some other embodiments, the lactase preparations set forth in PCT Publication No. WO 2017/167848 are used in the flavor-modifying compositions disclosed herein. In some other embodiments, the lactase preparations set forth in PCT Publication No. WO 2017/167849 are used in the flavor-modifying compositions disclosed herein.

In some embodiments, the flavor-modifying composition comprises a sweetness enhancer. As used herein, the term “sweetness enhancer” refers to a compound that agonizes the activation of a sweetener of a human T1R2 or T1R3 receptor in the course of in vitro screening or that is reported to agonize the perceived sweetness of such sweeteners via sensory testing by human subjects.

Any suitable sweetness enhancer can be used in the flavor-modifying compositions disclosed herein, including synthetic sweetness enhancers, natural sweetness enhancers, or any combinations thereof.

Examples of suitable synthetic sweetness enhancers include, but are not limited to, N-(1-((4-amino-2,2-dioxo-1H-benzo[c][1,2,6]thiadiazin-5-yl)oxy)-2-methylpropan-2-yl)isonicotinamide, or any of its comestbly acceptable salts, or any compounds set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032.

Suitable examples of natural sweetness enhancers include, but are not limited to, hesperetin dihydrochalcone, hesperetin dihydrochalcone-4′-O′glucoside, neohesperetin dihydrochalcone, brazzein, hesperidin, phyllodulcin, naringenin, naringin, phloretin, glucosylated steviol glycosides, (2R,3R)-3-acetoxy-5,7,4′-trihydroxyflavanone, (2R,3R)-3-acetoxy-5,7,3′-trihydroxy-4′-methoxyflavanone, rubusosides, thaumatin, monellin, miraculin, glycyrrhizin and comestible acceptable salts thereof (such as the mono-ammonium salt), naringin dihydrochalcone, myricetin, nobiletin, polymethoxyflavones, mixed methoxy- and hydroxyflavones, quercetin, certain amino acids, and the like. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1,6 bond, a β-1,2 bond, a β-1,4 bond, a β-1,6 bond, and so forth.

In some embodiments of any of the preceding embodiments, the comestible composition comprises 3-((4-amino-2,2-dioxo-1H-benzo[c][1,2,6]thiadiazin-5-yl)oxy)-2,2-dimethyl-N-propyl-propanamide, N-(1-((4-amino-2,2-dioxo-1H-benzo[c][1,2,6]-thiadiazin-5-yl)oxy)-2-methyl-propan-2-yl)isonicotinamide, or a comestibly acceptable salt thereof. In some embodiments, the flavor-modifying composition comprises N-(1-((4-amino-2,2-dioxo-1H-benzo[c][1,2,6]thiadiazin-5-yl)oxy)-2-methyl-propan-2-yl)isonicotinamide, or a comestbly acceptable salt thereof. In some embodiments, the flavor-modifying composition comprises N-(1-((4-amino-2,2-dioxo-1H-benzo[c][1,2,6]thiadiazin-5-yl)oxy)-2-methyl-propan-2-yl)isonicotinamide, and 3-hydroxybenzoic acid.

The sweetness enhancer can be present in the flavor-modifying composition in any suitable amount relative to the lactase. In some embodiments, the weight ratio of lactase to sweetness enhancer in the flavor-modifying composition ranges from 1:1 to 20:1, or from 1:1 to 10:1, of from 2:1 to 8:1.

In some embodiments, the flavor-modifying composition comprises one or more sweeteners. Any suitable sweetener can be used, including caloric, low-calorie, or zero-calorie sweeteners. In some other embodiments, the sweetener may be omitted from the flavor-modifying composition (and a sweetness enhancer is present, according to any of the embodiments set forth above) and the sweetener is included in a comestible composition of flavored product to which the flavor-modifying composition is introduced. Various embodiments of sweeteners are set forth in further detail below, which is incorporated herein by reference.

In embodiments where a sweetener is present in the flavor-modifying composition, the sweetener can have any suitable concentration relative to the lactase. In embodiments where the sweetener is a low-intensity caloric sweetener, the weight ratio of the sweetener to the lactase ranges from 10:1 to 500:1, or from 20:1 to 300:1. Any low-intensity caloric sweeteners (or combination of sweeteners) can be used. Non-limiting examples include sucrose, fructose, high-fructose corn syrup, D-glucose, lactose, D-galactose, and maltose. In some embodiments the sweetener is sucrose. In some embodiments the sweetener is fructose.

In embodiments where the sweetener is a low-intensity low-caloric sweetener, the weight ratio of the sweetener to the lactase ranges from 10:1 to 500:1, or from 20:1 to 300:1. Any low-intensity low-caloric sweeteners (or combination of sweeteners) can be used, either alone or in combination with caloric sweeteners or high-intensity sweeteners. Non-limiting examples include erythritol, allulose, xylitol, sorbitol, tagatose, mannitol, maltitol, lactitol, and isomalt.

In embodiments where the sweetener is a high-intensity sweetener, the weight ratio of the sweetener to the lactase ranges from 1:20 to 2:1, or from 1:10 to 1:1. Any high-intensity sweeteners (or combination of sweeteners) can be used, either alone or in combination with caloric sweeteners or high-intensity sweeteners. Non-limiting examples include acesulfame potassium, aspartame, neotame, cyclamate, saccharin, sucralose, steviol glycodised (such as rebaudioside A, rebaudioside M, rebaudioside D, rebaudioside E, and any combination thereof), and mogrosides (such as mogroside III, mogroside IV, mogroside V, siamenoside I, isomogroside V, mogroside IV_{E}, isomogroside IV, mogroside III_{E}, 11-oxomogroside V, the 1,6-α isomer of siamenoside I, and any combinations thereof). In some embodiments, the sweetener is a steviol glycoside, such as rebaudioside A or rebaudioside M. In some embodiments, the flavor-modifying composition comprises sucralose. In some other embodiments, the flavor-modifying composition comprises mogrodides, such as mogroside V, isomogroside V, siamenoside I, or the 1,6-α isomer of siamenoside I.

In some embodiments, the flavor-modifying compositions comprise a flavoring. When present, the flavoring improves the taste and flavor of the comestible composition or the resulting flavored product in which the comestible composition is used. Such improvement includes reducing the bitterness of the comestible composition or the resulting flavored product, reducing the perception of astringency of the comestible composition or the resulting flavored product, reducing the perception of green taste notes (such as pea taste) of the comestible composition or the resulting flavored product, reducing the perception of cereal notes of the comestible composition or the resulting flavored product, improving the perception of creaminess of the comestible composition or the resulting flavored product, improving the perception of creaminess of the comestible composition or the resulting flavored product, improving the perception of fattiness of the comestible composition or the resulting flavored product, improving the perception of sweetness of the comestible composition or the resulting flavored product, improving the perception of savory taste (umami or kokumi) of the comestible composition or the resulting flavored product, improving the mouthfeel or mouthcoating of the comestible composition or the resulting flavored product, improving the perception of juiciness of the comestible composition or the resulting flavored product, improving the perception of thickness of the comestible composition or the resulting flavored product, improving the vanillic character of the comestible composition or the resulting flavored product, or any combination thereof.

Any suitable flavoring can be used. In some embodiments, the flavoring comprises synthetic flavor oils and flavoring aromatics or oils, oleoresins and extracts derived from plants, leaves, flowers, fruits, and so forth, or combinations thereof. Non-limiting examples of flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Non-limiting examples of other flavors include natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. In the context of dairy or dairy analog products, the most commonly used flavor agents are agents that impart flavors such as vanilla, French vanilla, chocolate, banana, lemon, hazelnut, coconut, almond, strawberry, mocha, coffee, tea, chai, cinnamon, caramel, cream, brown sugar, toffee, pecan, butter pecan, toffee, Irish crème, white chocolate, raspberry, pumpkin pie spice, peppermint, or any combination thereof.

In some embodiments, the flavor-modifying composition comprises vanillin or a vanillin analogue, which impart a vanilla flavor to the flavoring. In some further embodiments, the flavor-modifying composition comprises one or more lactones, which impart a creamy flavor to the flavoring.

In some embodiments, the flavor-modifying composition comprises a yeast extract, such as a yeast lysate. Such extracts can be obtained from any suitable yeast strain, where such extracts are suitable for human consumption. Non-limiting examples of such yeasts include: yeasts of the genus Saccharomyces, such as Saccharomyces cerevisiae or Saccharomyces pastorianus; yeasts of the genus Candida, such as Candida utilis; yeasts of the genus Kluyveromyces, such as Kluyveromyces lactis or Kluyveromyces marxianus; yeasts of the genus Pichia such as Pichia pastoris; yeasts of the genus Debaryomyces such as Debaryomyces hansenii; and yeasts of the genus Zygosaccharomyces such as Zygosaccharomyces mellis. In some embodiments, the yeast is a yeast collected after brewing beer, sake, or the like. In some embodiments, the yeast is a yeast subjected to drying treatment (dried yeast) after collection.

Such extracts can be produced by any suitable means. In general, yeast extracts or lysates are made by extracting the contents of the yeast cells from the cell wall material. In many instances, the digestive enzymes in the cells (or additional enzymes added to the composition) break down the proteins and polynucleotides in the yeast to amino acids, oligopeptides (for example, from 2 to 10 peptides), nucleotides, oligonucleotides (from 2 to 10 nucleotides), and mixtures thereof. A yeast lysate can be prepared by lysing a yeast. For example, in some embodiments, the yeast after culture is crushed or lysed by an enzymatic decomposition method, a self-digestion method, an alkaline extraction method, a hot water extraction method, an acid decomposition method, an ultrasonic crushing method, crushing with a homogenizer, a freezing-thawing method, or the like (two or more thereof may be used in combination), whereby a yeast lysate is obtained. Yeast may be cultured by a conventional method. In some embodiments, the yeast after culture is heat-treated and then treated with a lytic enzyme to obtain an enzyme lysate. The conditions for the heat treatment are, for example, 80° C. to 90° C. for 5 minutes to 30 minutes. As the lytic enzyme used for the enzymatic decomposition method, various enzymes can be used as long as they can lyse the cell wall of yeast. The reaction conditions may be set so as to be optimum or suitable for the lytic enzyme(s) to be used, and specific examples thereof can include a temperature of 50° C. to 60° C., and a pH of 7.0 to 8.0. The reaction time is also not particularly limited, and can be, for example, 3 hours to 5 hours.

Compositions comprising yeast lysate can be obtained from a variety of commercial sources. For example, in some embodiments, the yeast lysate is provides by the flavoring additive sold under the name MODUMAX (DSM Food Specialties BV, Delft, Netherlands).

In some further embodiments, the flavor-modifying composition comprises one or more umami enhancing compounds. Such umami enhancing compounds include, but are not limited to, naturally derived compounds, or synthetic compounds, such as any compounds set forth in U.S. Pat. Nos. 8,735,081; 8,124,121; and 8,968,708. In some embodiments, the umami-enhancing compound is (2R,4R)-1,2,4-trihydroxy-heptadec-16-ene, (2R,4R)-1,2,4-trihydroxyheptadec-16-yne, or a mixture thereof. In some embodiments, the umami-enhancing compound is (3R,5S)-1-(4-hydroxy-3-methoxyphenyl)decane-3,5-diol diacetate.

In some embodiments, the umami-enhancing compound is N-(heptan-4-yl)benzo-[d][1,3]dioxole-5-carboxamide.

In some further embodiments, the flavor-modifying composition comprises one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727.

In some further embodiments, the flavor-modifying composition comprises one or more bitterness blocking compounds. Such bitterness blocking compounds include, but are not limited to, naturally derived compounds, such as menthol or analogs thereof, or synthetic compounds, such as any compounds set forth in U.S. Pat. Nos. 8,076,491; 8,445,692; and 9,247,759. In some embodiments, the bitterness blocking compound is 3-(1-((3,5-dimethylisoxazol-4-yl)-methyl)-1H-pyrazol-4-yl)-1-(3-hydroxybenzyl)-imidazolidine-2,4-dione.

In some further embodiments, the flavor-modifying composition comprises one or more sour taste modulating compounds.

In some further embodiments, the flavor-modifying composition comprises one or more mouthfeel modifying compounds. Such mouthfeel modifying compounds include, but are not limited to, tannins, cellulosic materials, bamboo powder, and the like.

In some further embodiments, the flavor-modifying composition comprises one or more flavor masking compounds. Such flavor masking compounds include, but are not limited to, cellulosic materials, materials extracted from fungus, materials extracted from plants, citric acid, carbonic acid (or carbonates), and the like.

In some embodiments, the flavor-modifying compounds described above are included to improve other tastants that may be present in the comestible composition itself, or that may be included within the flavored products that employ such compositions. Such tastants include sweeteners, umami tastants, kokumi tastants, bitter tastants, sour tastants, and the like.

### Uses and Methods

In certain aspects, the disclosure provides uses of any flavor-modifying compositions set forth above to increase or enhance a sweet taste of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of increasing or enhancing a sweet taste of a comestible composition, the method comprising introducing any flavor-modifying compositions set forth above to the comestible composition.

In certain aspects, the disclosure provides uses of any flavor-modifying compositions set forth above to reduce or block the bitterness of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of reducing or blocking the sweetness of a comestible composition, the method comprising introducing any flavor-modifying compositions set forth above to the comestible composition.

In certain aspects, the disclosure provides uses of any flavor-modifying compositions set forth above to reduce the perceived astringency of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of reducing the perceived astringency of a comestible composition, the method comprising introducing any flavor-modifying compositions set forth above to the comestible composition.

In certain aspects, the disclosure provides uses of any flavor-modifying compositions set forth above to reduce the perception of green taste notes (e.g., pea notes) of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of reducing the perception of green taste notes (e.g., pea notes) of a comestible composition, the method comprising introducing any flavor-modifying compositions set forth above to the comestible composition.

In certain aspects, the disclosure provides uses of any flavor-modifying compositions set forth above to reduce the perception of cereal taste notes of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of reducing the perception of cereal taste notes of a comestible composition, the method comprising introducing any flavor-modifying compositions set forth above to the comestible composition.

In certain aspects, the disclosure provides uses of any flavor-modifying compositions set forth above to enhance the perceived creaminess of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of enhancing the perceived creaminess of a comestible composition, the method comprising introducing any flavor-modifying compositions set forth above to the comestible composition.

In certain aspects, the disclosure provides uses of any flavor-modifying compositions set forth above to enhance the perceived fattiness of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of enhancing the perceived fattiness of a comestible composition, the method comprising introducing any flavor-modifying compositions set forth above to the comestible composition.

In certain aspects, the disclosure provides uses of any flavor-modifying compositions set forth above to increase or enhance a savory taste (such as an umami or a kokumi taste) of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of increasing or enhancing a savory taste (such as an umami or kokumi taste) of a comestible composition, the method comprising introducing any flavor-modifying compositions set forth above to the comestible composition.

In certain aspects, the disclosure provides uses of any flavor-modifying compositions set forth above to enhance the mouthfeel or mouthcoating of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of increasing the mouthfeel or mouthcoating of a comestible composition, the method comprising introducing any flavor-modifying compositions set forth above to the comestible composition.

In certain aspects, the disclosure provides uses of any flavor-modifying compositions set forth above to enhance the perceived juiciness of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of enhancing the perceived juiciness of a comestible composition, the method comprising introducing any flavor-modifying compositions set forth above to the comestible composition.

In certain aspects, the disclosure provides uses of any flavor-modifying compositions set forth above to enhance the perceived thickness of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of enhancing the perceived thickness of a comestible composition, the method comprising introducing any flavor-modifying compositions of the first aspect to the comestible composition.

In certain aspects, the disclosure provides uses of any flavor-modifying compositions set forth above to enhance the vanillic character of a comestible composition. In some embodiments, the comestible composition is a flavored product, such as a food product, a beverage product, an oral care product, or an animal feed product. In some embodiments, the comestible composition comprises one or more dairy proteins. In some embodiments, the comestible composition comprises one or more non-animal proteins, such as plant proteins, mycoproteins, algal proteins, or any combinations thereof. In some embodiments, the comestible composition comprises lactose (i.e., β-D-galactopyranosyl-(1→4)-D-glucose). In certain related aspects, the disclosure provides methods of enhancing the vanillic character of a comestible composition, the method comprising introducing any flavor-modifying compositions set forth above to the comestible composition.

The comestible compositions recited in the aspects and embodiments of the foregoing uses and methods may include a number of other features, as set forth in further detail below.

### Comestible Compositions

The comestible compositions disclosed herein comprise a flavor-modifying composition according to any of the aspects and embodiments set forth above. In general, the flavoring improves the taste and flavor of the comestible composition or the resulting flavored product in which the comestible composition is used. Such improvement includes reducing the bitterness of the comestible composition or the resulting flavored product, reducing the perception of astringency of the comestible composition or the resulting flavored product, reducing the perception of green taste notes (such as pea taste) of the comestible composition or the resulting flavored product, reducing the perception of cereal notes of the comestible composition or the resulting flavored product, improving the perception of creaminess of the comestible composition or the resulting flavored product, improving the perception of creaminess of the comestible composition or the resulting flavored product, improving the perception of fattiness of the comestible composition or the resulting flavored product, improving the perception of sweetness of the comestible composition or the resulting flavored product, improving the perception of savory taste (umami or kokumi) of the comestible composition or the resulting flavored product, improving the mouthfeel or mouthcoating of the comestible composition or the resulting flavored product, improving the perception of juiciness of the comestible composition or the resulting flavored product, improving the perception of thickness of the comestible composition or the resulting flavored product, improving the vanillic character of the comestible composition or the resulting flavored product, or any combination thereof.

In some embodiments, the comestible composition includes an additional flavoring. Any suitable additional flavoring can be used. In some embodiments, such a flavoring comprises synthetic flavor oils and flavoring aromatics or oils, oleoresins and extracts derived from plants, leaves, flowers, fruits, and so forth, or combinations thereof. Non-limiting examples of flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Non-limiting examples of other flavors include natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. In the context of dairy or dairy analog products, the most commonly used flavor agents are agents that impart flavors such as vanilla, French vanilla, chocolate, banana, lemon, hazelnut, coconut, almond, strawberry, mocha, coffee, tea, chai, cinnamon, caramel, cream, brown sugar, toffee, pecan, butter pecan, toffee, Irish crème, white chocolate, raspberry, pumpkin pie spice, peppermint, or any combination thereof.

In some embodiments, the comestible compositions comprise non-meat animal proteins, such as dairy proteins or proteins from bone broth. Such proteins can impart flavors that lack the flavor that consumers may desire for such products. This is especially true for protein isolates, such as protein isolates of whey protein, collagen protein, casein proteins, and the like. Thus, the flavor-modifying compositions of the preceding aspects can be used to improve the flavor of comestible compositions comprising such proteins. In some embodiments, the non-meat animal protein is a bone protein, such as a collagen protein derived from the bones of an animal, such as a cow, pig, donkey, horse, chicken, duck, goat, goose, rabbit, lamb, sheep, buffalo, ostrich, camel, and the like. In some embodiments, the non-meat animal protein is a milk protein, such as a whey protein, a casein protein, or any combination thereof. The milk can be the milk of any suitable animal, such as a cow, donkey, horse, sheep, buffalo, camel, and the like.

The comestible compositions disclosed herein can also be included in certain food or beverage products that include animal milk or materials derived from animal milk. Such products include cheeses, cheese spreads, yogurt, kefir, milk, processed dairy products, cottage cheese, sour cream, butter, and the like.

In some other embodiments, the comestible composition comprises a non-animal protein, such as a plant protein, an algal protein, or a mycoprotein. In some embodiments, the comestible composition comprises a plant-based protein. Non-limiting examples of plant proteins include pea protein, soy protein, almond protein, cashew protein, canola (rapeseed) protein, chickpea protein, fava protein, sunflower protein, wheat protein, oat protein, and potato protein.

The flavored products containing such non-animal proteins can be any suitable product. In some embodiments, the flavored product is a beverage, such as soy milk, almond milk, rice milk, coconut milk, oat milk, a protein drink, a meal-replacement drink, a dairy-free yogurt or kefir product, and the like. In some instances, such products are designed to simulate dairy products, and may be referred to as dairy analogue products. In some other embodiments, the flavored product is a meat-replacement product, such as a plant-based chicken product (such as a plant-based chicken nugget), a plant-based beef product (such as a plant-based burger), and the like. In some other embodiments, the flavored product is a protein powder, a meal-replacement powder, a plant-based creamer for coffee or tea, and the like. In certain further embodiments, any such products contain additional ingredients, and have additional features, as are typically used in the preparation and/or manufacture of such products.

For comestible compositions that include any of the above proteins, the proteins can be present in the comestible composition at any suitable ratio to the lactase in the flavor-modifying composition. For example, in some embodiments, the weight ratio of non-meat animal protein or non-animal protein to the lactase introduced to the comestible composition ranges from 10:1 to 500:1, or from 20:1 to 200:1, or from 30:1 to 150:1.

In some embodiments, the comestible compositions comprise hydrocolloids and other fiber blends that provide texture and thickening properties to the resulting flavored product. As used herein, the term “hydrocolloid” refers to materials that are colloidally dispersible in water, meaning that they form colloidal suspensions in water. In most instances, when such hydrocolloids are dispersed in water, the hydrocolloids do not settle and are not separable from the water by filtration. Hydrocolloids can include plant-based fibers, other non-animal-derived (plant-derived, algae-derived, or fungus-derived) polysaccharides, and polypeptides. Examples of hydrocolloids are materials that commonly form gels, sols, and emulsions in water, including pectin, cellulose ethers, carrageenan, guar gum, gelatin, alginate, gum arabic, psyllium husk fiber (or gum), xanthan gum, locust bean gum, a cellulose, a cellulose derivative (such as methylcellulose, carboxymethylcellulose, hydroxypropylmethylcellulose, and the like), chitosan, dextran, maltodextrin, inulin, n-octenyl succinic anhydride, tara gum, glucomannan, galactmannan, gum tragacanth, microbial polysaccharides, proteins of microbial origin, and the like. In some embodiments, the hydrocolloid is a polysaccharise. In some other embodiments, the hydrocolloid is a protein. In some embodiments, the hydrocolloid is psyllium husk fiber. In some embodiments, the hydrocolloid comprises psyllium husk fiber in combination with one or more other hydrocolloids set forth above.

The hydrocolloid can make up any suitable proportion of the fiber content in the comestible composition. For example, in some embodiments, the fiber blend comprises from 10 percent by weight to 70 percent by weight, or from 20 percent by weight to 60 percent by weight, or from 30 percent by weight to 50 percent by weight, or from 35 percent by weight to 45 percent by weight, of psyllium fiber, based on the total weight of the fiber blend in the comestible composition.

In some embodiments, the fiber blend also comprises an insoluble fiber. In general, the insoluble fiber remains suspended in the hydrocolloid matrix when the fiber blend is introduced to water at 25° C. and atmospheric pressure, for example, for at least 2 days, or at least 3 days, or at least 4 days, or at least 5 days, or at least 6 days, or at least 7 days.

Any suitable insoluble fiber can be used. In some embodiments, the insoluble fiber is a plant-derived fiber. Non-limiting examples include nut fibers, grain fibers, rice fibers, seed fibers, oat fibers, pea fibers, potato fibers, berry fibers, soybean fibers, banana fibers, citrus fibers, apple fibers, and carrot fibers. In some embodiments, the insoluble fiber is pea fiber. The insoluble fiber can make up any suitable proportion of the fiber blend. For example, in some embodiments, the fiber blend comprises from 30 percent by weight to 90 percent by weight, or from 40 percent by weight to 80 percent by weight, or from 50 percent by weight to 70 percent by weight, or from 55 percent by weight to 65 percent by weight, based on the total weight of the fiber blend in the comestible composition.

In some embodiments, the fiber blend comprises a cross-linking agent for forming the hydrocolloids into a three-dimensional network structure. Non-limiting examples of suitable cross-linking agents include calcium chloride, calcium sulfate, calcium nitrate, zinc nitrate, zinc chloride, zinc sulfate, ammonium persulfate, and glutaraldehyde.

In some embodiments, the fiber blend comprises from 35 percent by weight to 45 percent by weight psyllium husk fiber (or gum) and from 55 percent by weight to 65 percent by weight pea fiber, both based on the total weight of the composition. In some further embodiments thereof, the fiber blend comprises no more than 5 percent by weight, or no more than 4 percent by weight, or no more than 3 percent by weight, or no more than 2 percent by weight, or no more than 1 percent by weight, of another insoluble fiber besides pea fiber.

In some embodiments, the comestible composition or the resulting flavored product comprises a sweetener. The sweetener can be present in any suitable concentration, depending on factors such as the sweetener's potency as a sweetener, its solubility, and the like. For example, in some embodiments, the sweetener is present in an amount from 0.1 weight percent to 12 weight percent. In some embodiments, the sweetener is present in an amount from 0.2% to 10% by weight. In some embodiments, the sweetener is present in an amount from 0.3% to 8% by weight. In some embodiments, the sweetener is present in an amount from 0.4% to 6% by weight. In some embodiments, the sweetener is present in an amount from 0.5% to 5% by weight. In some embodiments, the sweetener is present in an amount from 1% to 2% by weight. In some embodiments, the sweetener is present in an amount from 0.1% to 5% by weight. In some embodiments, the sweetener is present in an amount from 0.1% to 4% by weight. In some embodiments, the sweetener is present in an amount from 0.1% to 3% by weight. In some embodiments, the sweetener is present in an amount from 0.1% to 2% by weight. In some embodiments, the sweetener is present in an amount from 0.1% to 1% by weight. In some embodiments, the sweetener is present in an amount from 0.1% to 0.5% by weight. In some embodiments, the sweetener is present in an amount from 0.5% to 10% by weight. In some embodiments, the sweetener is present in an amount from 2% to 8% by weight. In some further embodiments of the embodiments set forth in this paragraph, the additional sweetener is sucrose, fructose (such as high-fructose corn syrup, fruit juice, and the like), glucose, xylitol, erythritol, glucose, allulose, or any combinations thereof. In some embodiments, the sweetener is sucrose.

In some other embodiments, the sweetener is present in an amount ranging from 10 ppm to 1000 ppm. In some embodiments, the sweetener is present in an amount from 20 ppm to 800 ppm. In some embodiments, the sweetener is present in an amount from 30 ppm to 600 ppm. In some embodiments, the sweetener is present in an amount from 40 ppm to 500 ppm. In some embodiments, the sweetener is present in an amount from 50 ppm to 400 ppm. In some embodiments, the sweetener is present in an amount from 50 ppm to 300 ppm. In some embodiments, the sweetener is present in an amount from 50 ppm to 200 ppm. In some embodiments, the sweetener is present in an amount from 50 ppm to 150 ppm. In some further embodiments of the embodiments set forth in this paragraph, the additional sweetener is a steviol glycoside (such as rebaudioside A, rebaudioside D, rebaudioside E, rebaudioside M, or any combination thereof), a mogroside (such as mogroside III, mogroside IV, mogroside V, siamenoside I, isomogroside V, mogroside IV_{E}, isomogroside IV, mogroside III_{E}, 11-oxomogroside V, the 1,6-α isomer of siamenoside I, and any combinations thereof), a derivative of either of the foregoing, such as glycoside derivatives (e.g., glucosylates), cyclamate, aspartame, sucralose, acesulfame K, or any combination thereof.

In general, the comestible compositions and flavored products can include any suitable sweeteners or combination of sweeteners. In some embodiments, the sweetener is a common saccharide sweeteners, such as sucrose, fructose, glucose, and sweetener compositions comprising natural sugars, such as corn syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, allulose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some embodiments, the additional sweetener is a combination of two or more of the sweeteners set forth in this paragraph. In some embodiments, the sweetener may combinations of two, three, four or five sweeteners as disclosed herein. In some embodiments, the additional sweetener is a sugar. In some embodiments, the additional sweetener is a combination of one or more sugars and other natural and artificial sweeteners. In some embodiments, the additional sweetener is a sugar. In some embodiments, the sugar is cane sugar. In some embodiments, the sugar is beet sugar. In some embodiments, the sugar may be sucrose, fructose, glucose or combinations thereof. In some embodiments, the sugar is sucrose. In some embodiments, the sugar is a combination of fructose and glucose.

In some embodiments, the sweeteners can also include, for example, sweetener compositions comprising one or more natural or synthetic carbohydrate, such as corn syrup, high fructose corn syrup, high maltose corn syrup, glucose syrup, sucralose syrup, hydrogenated glucose syrup (HGS), hydrogenated starch hydrolyzate (HSH), or other syrups or sweetener concentrates derived from natural fruit and vegetable sources, or semi-synthetic “sugar alcohol” sweeteners such as polyols. Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, isomaltulose, maltodextrin, and the like, and sugar alcohols or any other carbohydrates or combinations thereof capable of being reduced which do not adversely affect taste.

The sweetener may be a natural or synthetic sweetener that includes, but is not limited to, agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

In still other embodiments, the sweetener can be a chemically or enzymatically modified natural high potency sweetener. Modified natural high potency sweeteners include glycosylated natural high potency sweetener such as glucosyl-, galactosyl-, or fructosyl-derivatives containing 1-50 glycosidic residues. Glycosylated natural high potency sweeteners may be prepared by enzymatic transglycosylation reaction catalyzed by various enzymes possessing transglycosylating activity. In some embodiments, the modified sweetener can be substituted or unsubstituted.

Additional sweeteners also include combinations of any two or more of any of the aforementioned sweeteners. In some embodiments, the sweetener may comprise combinations of two, three, four or five sweeteners as disclosed herein. In some embodiments, the sweetener may be a sugar. In some embodiments, the sweetener may be a combination of one or more sugars and other natural and artificial sweeteners. In some embodiments, the sweetener is a caloric sweetener, such as sucrose, fructose, xylitol, erythritol, or combinations thereof. In some embodiments, the comestible compositions are free (or, in some embodiments) substantially free of stevia-derived sweeteners, such as steviol glycosides, glucosylated steviol glycosides, or rebaudiosides. For example, in some embodiments, the comestible compositions are either free of stevia-derived sweeteners or comprise stevia-derived sweeteners in a concentration of no more than 1000 ppm, or no more than 500 ppm, or no more than 200 ppm, or no more than 100 ppm, or no more than 50 ppm, or no more than 20 ppm, or no more than 10 ppm, or no more than 5 ppm, or no more than 3 ppm, or no more than 1 ppm.

In some embodiments, the comestible composition comprises rebaudioside A and glucosylated steviol glycosides. The rebaudioside A can be present at any concentration such as those indicated above. The glucosylated steviol glycosides can be present at concentrations ranging from 1 ppm to 50 ppm, or from 1 ppm to 40 ppm, or from 1 ppm to 30 ppm, or from 1 ppm to 20 ppm, or from 1 ppm to 10 ppm. In some other embodiments, the rebaudioside A can be partially replaced by other steviol glycoside sweeteners, such as rebaudioside M.

In some embodiments, the hydrolyzed dairy composition further comprises lactose hydrolysis products, such as galactose and glucose, which are formed when lactase from the flavor-modifying composition hydrolyzes lactose present in the comestible composition. Thus, in some embodiments, the lactose hydrolysis products are derived from the hydrolysis of at least a portion of the lactose, for example, by a lactase. Thus, in some embodiments, the comestible composition comprises lactose, glucose, and galactose.

In some embodiments, the introduction of the lactase-containing flavor-modifying composition to the comestible composition results in the hydrolysis of at least a portion of the lactose present in the comestible composition, such as at least 50%, or at least 60%, or at least 70%, or at least 80%, or at least 90%, or at least 95%, or at least 98% of the lactose present in the comestible composition prior to introduction of the lactase. In some embodiments, the weight/weight ratio of lactose hydrolysis products to lactose in the comestible composition ranges from 2:1 to 100:1, or from 3:1 to 100:1, or from 4:1 to 100:1, or from 5:1 to 100:1, or from 10:1 to 100:1, or from 20:1 to 100:1, or from 40:1 to 100:1, or from 50:1 to 100:1.

In some embodiments, the comestible composition comprises an emulsifier, such as a non-hydrocolloid emulsifier. Any suitable non-hydrocolloid emulsifier can be used. For example, in some non-limiting embodiments, the emulsifier comprises lecithin, monoglycerides, diglycerides, polysorbates, vegetable oils, and the like. In some embodiments, the emulsifier comprises lecithin. The emulsifier can be present in any suitable concentration, which can be adjusted so as to form a stable emulsion of the other components in the comestible composition, for example, when incorporated into a flavored product.

In some instances, it may be desirable to include additives that assist in adjusting the viscosity of the resulting flavored product (for example, when the comestible composition is introduced into water). Various salts and acids can be used to carry out such adjustments. In some embodiments, the comestible composition or the resulting flavored product comprises one or more salts. Non-limiting examples of suitable salts include magnesium sulfate, sodium chloride, sodium sulfate, calcium chloride, calcium sulfate, potassium sulfate, potassium chloride, potassium sorbate, potassium phosphate, potassium monophosphate, zinc chloride, zinc sulfate, or any mixtures thereof. In some embodiments, the comestible composition or the resulting flavored product also comprises one or more acids, which may be used alone or in combination with the aforementioned salts. Non-limiting examples of suitable acids include citric acid, lactic acid, acetic acid, tartaric acid, succinic acid, ascorbic acid, maleic acid, phosphoric acid, monopotassium phosphate, gluconic acid, glucono-lactone, glucoronic acid, glycyrrhetic acid, folic acid, pantothenic acid or mixtures thereof.

The comestible compositions can, in certain embodiments, comprise any additional ingredients or combination of ingredients as are commonly used in food and beverage products, including, but not limited to:
acids, including, for example citric acid, phosphoric acid, ascorbic acid, sodium acid sulfate, lactic acid, or tartaric acid;
bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi);
coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;
preservatives, including, for example sodium benzoate, potassium benzoate, potassium sorbate, sodium metabisulfate, sorbic acid, or benzoic acid;
antioxidants including, for example ascorbic acid, calcium disodium EDTA, alpha tocopherols, mixed tocopherols, rosemary extract, grape seed extract, resveratrol, or sodium hexametaphosphate;
vitamins or functional ingredients including, for example resveratrol, Co-Q10, omega 3 fatty acids, theanine, choline chloride (citocoline), fibersol, inulin (chicory root), taurine, panax ginseng extract, guanana extract, ginger extract, L-phenylalanine, L-carnitine, L-tartrate, D-glucoronolactone, inositol, bioflavonoids, Echinacea, ginko biloba, yerba mate, flax seed oil, garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulphate;
clouding agents, including, for example ester gun, brominated vegetable oil (BVO), or sucrose acetate isobutyrate (SAIB);
buffers, including, for example sodium citrate, potassium citrate, or salt;
propylene glycol, ethyl alcohol, glycerine, gum Arabic (gum acacia), modified corn starch, silicon dioxide, magnesium carbonate, or tricalcium phosphate; or
starches and stabilizers, including, for example, polysorbate 60, polysorbate 80, medium chain triglycerides, and the like.

In some embodiments, component (a) can further comprise galact-oligosaccharides, fructo-oligosaccharides, acacia fiber, soluble pea fiber, soluble wheat fiber, arabinoxylan, isomalto-oligosaccharides, xylo-oligosaccharides, and the like.

### Flavored Products

In certain aspects, the disclosure provides flavored products, which comprise any comestible compositions of the aspects and embodiments set forth above. In some embodiments, the flavored products are beverage products, such as dairy or dairy analogue products. In some other embodiments, the flavored products are food products, such as yogurt. In some embodiments, the flavored products are animal feed product, such as cat feed or dog feed products. In some embodiments, the flavored products are oral care products, such as mouthwash, toothpaste, tooth-whitening products, and the like.

In certain embodiments, the flavored products are dairy products. As used herein, the term “dairy product” refers to a food product where a major constituent is milk-based. In some aspects, the major constituent is a milk-based substrate which has been treated with an enzyme having lactase activity. In the context of the present disclosure a “major constituent” refers to a constituent having a dry matter which constitutes at least 20% by weight, or at least 30% by weight, or at least 40% by weight, or at least 50% by weight, or at least 60% by weight, or at least 70% by weight, of the total dry matter of the dairy product. Non-limiting examples of dairy products include skim milk, low-fat milk, whole milk, cream, UHT milk, milk having an extended shelf life, a fermented milk product, cheese, yoghurt, butter, dairy spread, butter milk, acidified milk drink, sour cream, whey based drink, ice cream, condensed milk, dulce de leche, and a flavored milk drink. Such dairy products may be manufactured by any method known in the art.

A dairy product may additionally comprise non-milk components, such as vegetable components such, for example, vegetable oil, vegetable protein, or vegetable carbohydrates. Dairy products may also comprise further additives, such as enzymes, flavoring agents, microbial cultures such as probiotic cultures, salts, sweeteners, sugars, acids, fruit, fruit juices, or any other component known in the art as a component of, or additive to, a dairy product.

In some embodiments, the dairy product is a dairy product that is not enriched by the addition of galactooligosaccharides. In some embodiments, the enzyme-treated milk-based substrate is not dried before being used as an ingredient in the dairy product.

In some embodiments, the dairy product is ice cream. In the present context, ice cream may be any kind of ice cream such as full fat ice cream, low fat ice cream, or ice cream based on yoghurt or other fermented milk products. Ice cream may be manufactured by any method known in the art.

In some embodiments, the dairy product is milk or condensed milk. The condensed milk may be manufactured by any method known in the art.

In some embodiments, the dairy product is UHT milk. UHT milk in the context of the present disclosure is milk which has been subjected to a sterilization procedure which is intended to kill all microorganisms, including the bacterial spores. UHT (ultra high temperature) treatment includes, for example, heat treatment for at least 30 seconds at a temperature of about 130° C., or heat treatment for at least one second at a temperature of about 145° C.

In some embodiments, the dairy product is ESL milk. ESL milk in the context of the present invention is milk which has an extended shelf life due to microfiltration or heat treatment and which is able to stay fresh for at least 15 days, preferably for at least 20 days, on the store shelf at 2-5° C.

In some aspects, the dairy product is a lactic fermented dairy product, such as yogurt. The yogurt can be any suitable kind of yogurt, including Greek-style yogurt.

A “fermented dairy product” in the context of the present disclosure is to be understood as any dairy product wherein any type of fermentation forms part of the production process. Non-limiting examples of fermented dairy products include products such as yogurt, buttermilk, creme fraiche (sour cream), quark, and fromage frais. A fermented dairy product may be produced by any method known in the art.

In certain embodiments, “fermentation” refers to the conversion of carbohydrates into alcohols or acids through the action of one or more microorganisms. Alternatively, in some other embodiments, “fermentation” refers to the conversion of lactose to lactic acid.

In the context of the present disclosure, “microorganism” includes any bacterium, yeast, mold, or fungus being able to ferment the milk substrate.

The microorganisms used for most fermented milk products are selected from the group of bacteria generally referred to as lactic acid bacteria. As used herein, the term “lactic acid bacterium” designates a gram-positive, microaerophilic or anaerobic bacterium, which ferments sugars with the production of acids including lactic acid as the predominantly produced acid, acetic acid and propionic acid. The industrially most useful lactic acid bacteria are found within the order “Lactobacillales” which includes Lactococcus spp., Streptococcus spp., Lactobacillus spp., Leuconostoc spp., Pseudoleuconostoc spp., Pediococcus spp., Brevibacterium spp., Enterococcus spp. and Propionibacterium spp. Additionally, lactic acid producing bacteria belonging to the group of anaerobic bacteria, bifidobacteria, i.e. Bifidobacterium spp., which are frequently used as food cultures alone or in combination with lactic acid bacteria, are generally included in the group of lactic acid bacteria.

Lactic acid bacteria are normally supplied to the dairy industry either as frozen or freeze-dried cultures for bulk starter propagation or as so-called “Direct Vat Set” (DVS) cultures, intended for direct inoculation into a fermentation vessel or vat for the production of a fermented dairy product. Such cultures are in general referred to as “starter cultures” or “starters.”

Commonly used starter culture strains of lactic acid bacteria are generally divided into mesophilic organisms having optimum growth temperatures at about 30° C. and thermophilic organisms having optimum growth temperatures in the range of about 40 to about 45° C. Typical organisms belonging to the mesophilic group include Lactococcus lactis, Lactococcus lactis subsp. cremoris, Leuconostoc mesenteroides subsp. cremoris, Pseudoleuconostoc mesenteroides subsp. cremoris, Pediococcus pentosaceus, Lactococcus lactis subsp. lactis biovar. diacetylactis, Lactobacillus casei subsp. casei and Lactobacillus paracasei subsp. paracasei. Thermophilic lactic acid bacterial species include as examples Streptococcus thermophilus, Enterococcus faecium, Lactobacillus delbrueckii subsp. lactis, Lactobacillus helveticus, Lactobacillus delbrueckii subsp. bulgaricus and Lactobacillus acidophilus.

Also the anaerobic bacteria belonging to the genus Bifidobacterium including Bifidobacterium bifidum, Bifidobacterium animalis and Bifidobacterium longum are commonly used as dairy starter cultures and are generally included in the group of lactic acid bacteria. Additionally, species of Propionibacteria are used as dairy starter cultures, in particular in the manufacture of cheese. Additionally, organisms belonging to the Brevibacterium genus are commonly used as food starter cultures.

Another group of microbial starter cultures are fungal cultures, including yeast cultures and cultures of filamentous fungi, which are particularly used in the manufacture of certain types of cheese and beverage. Examples of fungi include Penicillium roqueforti, Penicillium candidum, Geotrichum candidum, Torula kefir, Saccharomyces kefir and Saccharomyces cerevisiae.

In some embodiments, the microorganism used for fermentation of the milk-based substrate is Lactobacillus casei or a mixture of Streptococcus thermophilus and Lactobacillus delbrueckii subsp. bulgaricus.

Fermentation processes to be used in a method of the present disclosure are well known and the person of skill in the art will know how to select suitable process conditions, such as temperature, oxygen, amount and characteristics of microorganism/s, additives such as e.g. carbohydrates, flavors, minerals, enzymes, and process time. Obviously, fermentation conditions are selected so as to support the achievement of the present disclosure.

In some other embodiments where the flavored product is a beverage, the beverage may be selected from the group consisting of enhanced sparkling beverages, colas, lemon-lime flavored sparkling beverages, orange flavored sparkling beverages, grape flavored sparkling beverages, strawberry flavored sparkling beverages, pineapple flavored sparkling beverages, ginger-ales, root beers, fruit juices, fruit-flavored juices, juice drinks, nectars, vegetable juices, vegetable-flavored juices, sports drinks, energy drinks, enhanced water drinks, enhanced water with vitamins, near water drinks, coconut waters, tea type drinks, coffees, cocoa drinks, beverages containing milk components, beverages containing cereal extracts and smoothies. In some embodiments, the beverage may be a soft drink.

In some embodiments, the flavored product further comprises a carrier and, optionally, at least one adjuvant. The term “carrier” denotes a usually inactive accessory substance, such as solvents, binders, bulking agents, or other inert medium, which is used in combination with the present compound and one or more optional adjuvants to form the formulation. For example, water or starch can be a carrier for a flavored product. In some embodiments, the carrier is the same as the diluting medium for reconstituting the flavored product; and in other embodiments, the carrier is different from the diluting medium. The term “carrier” as used herein includes, but is not limited to, comestibly acceptable carrier.

The term “adjuvant” denotes an additive which supplements, stabilizes, maintains, or enhances the intended function or effectiveness of the active ingredient, such as the compound of the present invention. In one embodiment, the at least one adjuvant comprises one or more flavoring agents. The flavoring agent may be of any flavor known to one skilled in the art or consumers, such as the flavor of chocolate, coffee, tea, mocha, French vanilla, peanut butter, chai, or combinations thereof. In another embodiment, the at least one adjuvant comprises one or more sweeteners. The one or more sweeteners can be any of the sweeteners described in this application. In another embodiment, the at least one adjuvant comprises one or more ingredients selected from the group consisting of a emulsifier, a stabilizer, an antimicrobial preservative, an antioxidant, vitamins, minerals, fats, starches, protein concentrates and isolates, salts, and combinations thereof. Examples of emulsifiers, stabilizers, antimicrobial preservatives, antioxidants, vitamins, minerals, fats, starches, protein concentrates and isolates, and salts are described in U.S. Pat. No. 6,468,576, the content of which is hereby incorporated by reference in its entirety for all purposes.

The flavored product may further comprise a freezing point depressant, nucleating agent, or both as the at least one adjuvant. The freezing point depressant is an ingestibly acceptable compound or agent which can depress the freezing point of a liquid or solvent to which the compound or agent is added. That is, a liquid or solution containing the freezing point depressant has a lower freezing point than the liquid or solvent without the freezing point depressant. In addition to depress the onset freezing point, the freezing point depressant may also lower the water activity of the flavored product. The examples of the freezing point depressant include, but are not limited to, carbohydrates, oils, ethyl alcohol, polyol, e.g., glycerol, and combinations thereof. The nucleating agent denotes an ingestibly acceptable compound or agent which is able to facilitate nucleation. The presence of nucleating agent in the flavored product can improve the mouthfeel of the frozen Blushes of a frozen slush and to help maintain the physical properties and performance of the slush at freezing temperatures by increasing the number of desirable ice crystallization centers. Examples of nucleating agents include, but are not limited to, calcium silicate, calcium carbonate, titanium dioxide, and combinations thereof.

In some embodiments, the flavored product is formulated to have a low water activity for extended shelf life. Water activity is the ratio of the vapor pressure of water in a formulation to the vapor pressure of pure water at the same temperature. In one embodiment, the flavored product has a water activity of less than about 0.85. In another embodiment, the flavored product has a water activity of less than about 0.80. In another embodiment, the flavored product has a water activity of less than about 0.75.

### Methods of Preparation

The comestible compositions disclosed herein can be made by any suitable means, as typically employed in the manufacturing of products containing flavoring compositions. Such methods include dry mixing, granulating, encapsulating, spray drying, and the like.

### EXAMPLES

To further illustrate this invention, the following examples are included. The examples should not, of course, be construed as specifically limiting the invention. Variations of these examples within the scope of the claims are within the purview of one skilled in the art and are considered to fall within the scope of the invention as described, and claimed herein. The reader will recognize that the skilled artisan, armed with the present disclosure, and skill in the art is able to prepare and use the invention without exhaustive examples.

### Example 1—Sweetened Dairy Product

The flavor-modifying compositions disclosed herein are used to form a sweetened a dairy product. Table 1 shows two control formulations and one test formulation, which uses flavor-modifying compositions disclosed herein. Note that Sweet Enhancer A is N-(1-((4-amino-2,2-dioxo-1H-benzo[c][1,2,6]thiadiazin-5-yl)oxy)-2-methylpropan-2-yl)isonicotinamide.

TABLE 1

| | Control 1 | Control 2 | Test Formulation |
|---|---|---|---|
| INGREDIENTS | (wt %) | (wt %) | (wt %) |
| Dairy powders blend | 13 | 15 | 15 |
| Sugar | 47 | 43 | 43 |
| Bulking agent | 1.60 | 2.20 | 2.20 |
| Palm Oil | 12.20 | 12.50 | 12.50 |
| Lactase enzyme | — | — | 0.12 |
| Sweet Enhancer A | — | — | 0.022 |
| Water | Up to 100 | Up to 100 | Up to 100 |
| Total | 100.00 | 100.00 | 100.00 |

1. A flavor-modifying composition, the composition comprising:
(a) lactase; and
(b) a sweetness enhancer.

2. (canceled)

3. The composition of claim 1, wherein the composition does not comprise 3-((4-amino-2,2-dioxo-1H-benzo[c][1,2,6]thiadiazin-5-yl)oxy)-2,2-dimethyl-N-propylpropanamide.

4. The composition of claim 1, wherein the composition comprises N-(1-((4-amino-2,2-dioxo-1H-benzo[c][1,2,6]thiadiazin-5-yl)oxy)-2-methyl-propan-2-yl)isonicotinamide, or a comestibly acceptable salt thereof.

5. The composition of claim 1, wherein the composition further comprises hesperitin dihydrochalcone, hesperitin dihydrochalcone-4′-O'glucoside, neohesperitin dihydrochalcone, brazzein, hesperidin, phyllodulcin, naringenin, naringin, phloretin, glucosylated steviol glycosides, (2R,3R)-3-acetoxy-5,7,4′-trihydroxy-flavanone, (2R,3R)-3-acetoxy-5,7,3′-trihydroxy-4′-methoxyflavanone, rubusosides, thaumatin, monellin, miraculin, glycyrrhizin, naringin dihydrochalcone, myricetin, nobiletin, polymethoxyflavones, mixed methoxy- and hydroxyflavones, quercetin, amino acids, and any combination thereof.

6. The composition of claim 1, wherein the composition comprises a sweetener.

7. The composition of claim 6, wherein the sweetener is sucrose, fructose, rebaudioside A, rebaudioside D, rebaudioside E, rebaudioside M, sucralose, or any combination thereof.

8. A method of enhancing a sweet taste of a comestible composition, the method comprising introducing to the comestible composition a flavor-modifying composition of claim 1.

9. The method of claim 8, wherein the comestible composition comprises lactose.

10. The method of claim 8, wherein the comestible composition comprises one or more dairy proteins.

11. The method of claim 8, wherein the comestible composition comprises a non-animal protein.

12. A comestible composition, the composition comprising the flavor-modifying composition of claim 1 and lactose.

13. The composition of claim 12, wherein the composition further comprises one or more dairy proteins.

14. A flavored product, which comprises the comestible composition of claim 12.

15. The flavored product of claim 14, wherein the flavored product is a dairy product.
